(19) United States
(12) Patent Application Publication
(10) Pub. No.: US 2016/0332129 A1
(43) Pub. Date: Nov. 17, 2016

(54) RADIAL MODE FLUID PROCESS METER

(71) Applicant: Concentric Meter Corporation, Longmont, CO (US)

(72) Inventors: Michael N. Schott, Loveland, CO (US); Donald R. Cage, Longmont, CO (US); Kristian S. Schartau, Erie, CO (US)

(21) Appl. No.: 15/152,904

(22) Filed: May 12, 2016

Related U.S. Application Data
(60) Provisional application No. 62/161,758, filed on May 14, 2015.

(51) Int. Cl. B01F 15/00; B01F 11/00; G01N 11/16

(52) U.S. Cl. CPC B01F 15/00285; G01N 11/16; B01F 11/008; B01F 15/00246; B01F 15/00175; G01N 2011/0046

(57) ABSTRACT

A process meter and method for measurement of volume fraction of a slurry mixture. An example process meter includes a first viscosity meter configured to measure a first viscosity of the fluid and to generate a first viscosity signal proportionally related to the first viscosity. The example process meter also includes a second viscosity meter configured to measure a second viscosity of the slurry mixture and to generate a second viscosity signal proportionally related to the second viscosity. The example process meter also includes control electronics configured to receive the first viscosity signal and the second viscosity signal, and to calculate a volume fraction of the solid particles in the slurry mixture based on the first viscosity signal and the second viscosity signal. The control electronics is configured to create an output signal from the process meter proportionally related to the volume fraction, and to measure the volume fraction.

### CROSS REFERENCE TO RELATED APPLICATIONS

This application claims the priority benefit of U.S. Provisional Patent Application No. 62/161,758 filed May 14, 2015 for “Radial Mode Fluid Process Meter,” hereby incorporated by reference in its entirety as though fully set forth herein.

### BACKGROUND

In many industries, slurry fluids may be created and used for a variety of useful purposes. For example, in the hydraulic fracturing industry (“fracking”), a mixture of a base fluid and solid particles, usually water and sand, may be mixed together into a slurry fluid, and then pumped, for example, into an oil or gas well to improve its production. Similarly, during the drilling of an oil or gas well, a slurry fluid commonly called “mud” may be used to help the drilling process. This drilling mud is usually a mixture of water and bentonite particles. In these and many other examples, the volume fraction of solid particles in the slurry fluid mixture may need to be accurately known and controlled so that the correct fluid properties is achieved for the intended purposes. Existing apparatus and methods for the measurement of volume fraction of these slurries is often deficient in accuracy and in longevity.

### BRIEF DESCRIPTION OF THE DRAWINGS

FIG. 1 is a graph of relative viscosity vs. volume fraction showing three example algorithms predicting the relationship there between.

FIG. 2 is a block diagram of an example radial mode fluid process meter.

FIG. 3 illustrates an example radial active tube, looking at a cross section of the tube when it is in the neutral position.

FIG. 4 illustrates an example radial active tube changing shape as it is forced back and forth between a vertical elliptical shape and a horizontal elliptical shape connected to the inside diameter of an external pipe enclosure.

FIG. 6 illustrates an example of a fluid flowing on the outside diameter of a tube and fluid flowing on the inside diameter of a tube, when the radial active tube is forced into its horizontal shape.

FIG. 6 illustrates an example shear stress profile τ for fluid flowing at velocity ν with a distance y between flowing and stationary fluid.

FIG. 7 illustrates an example radial active inner tube process meter.

FIG. 8 illustrates an example Volume Fraction Calculation using one or more process meters on slurry mixing process.

### DETAILED DESCRIPTION

An apparatus and method is disclosed to measure the volume fraction of solid particles in a slurry fluid mixture whereby two viscosity process meters may be used to determine the viscosity of the base fluid prior to mixing with solid particles, and another viscosity process meter may be used to determine the viscosity of the slurry mixture after mixing. The determination of the volume fraction of solid particles in the slurry mixture may then made based on the change in the viscosity from before and then after the mixing. A process meter utilizing an inner active vibrating tube may be mounted inside a larger non-vibrating conduit, capable of measuring and outputting fluid viscosity and fluid temperature. The inner active vibrating tube and the fluid contained within the process meter may be forced into controlled oscillations using both force and feedback transducers. Where the inner active vibrating tube oscillates in a radial or hoop mode, it may shear the fluid contained within the process meter as it may be forced to radially move back and forth between adjacent inner active vibrating tube antinodes. With an adequately mixed fluid, the radial or hoop mode may always remain balanced as its center of mass may be located at the center of the inner active vibrating tube. The process meter calculated fluid viscosity output may be a function of force, velocity and temperature. Control and feedback electronics may use a known force to maintain a controlled velocity upon the inner active vibrating tube, and process meter temperature measurements may be used for known temperature compensations along with fluid temperature output. Furthermore, with fluid viscosities and/or viscous penetration depth entering and exiting a slurry mixing process, the solid and liquid volume fraction content and/or mass fraction content of the exiting slurry may be calculated.

In an example, a method of measuring volume fraction first measures the volume flow rate of the base fluid prior to mixing with solid particles. This first measurement may be relatively easy since the fluid is usually devoid of particulate matter and many flow meters exist that may be able to measure the volume flow rate of a clean fluid. A second volume flow rate measurement may then be made of the slurry after mixing the base fluid with the particulate matter. A simple comparison of these two volume flow rates generally may be able to identify the change in the volume flow rate from before mixing to that after mixing, and therefore may lead directly to a volume fraction calculation as in Equation 1 below:

VF=(\dot{V}mix−\dot{V}base)/\dot{V}mix Eq 1

Where:

VF=Volume Fraction

\dot{V}mix=Volume flow rate of the slurry mixture

\dot{V}base=Volume flow rate of the base fluid

While this may seem straightforward, a problem is that no volumetric flow meters exist to accurately measure the volume flow rate of an abrasive fluid over time, such as due to the wearing effects of the particulate matter. For example, positive displacement type flow meters typically depend on close fitting seals that wear out with abrasive slurries. Turbine and propeller type flow meters experience wear on their turbine blades and propellers that change their calibration over time. Coriolis type flow meters have vibrating tubes that may become worn and may lose their accuracy.

Therefore, an apparatus and method is disclosed for accurately determining the volume fraction of particles such as, but not limited to, in a slurry fluid, and that withstand rigors of the environment in which they operate, such as, but not limited to, abrasive flow.

An example includes a vibrating element type fluid process meter capable of measuring liquid and slurry fluid parameters, including, but not limited to, fluid viscosity, volumetric fraction, concentration, and temperature. The vibrating element may be an inner tube centered in a larger conduit and may use a radial mode of vibration, which maintains its center of gravity located at the active tube center, producing an inherently balanced system, if the process meter entrained fluid is adequately mixed.

Vibrating bending mode process meters attempting to measure viscosity operate in flexure and may implement dual flow tubes and/or a single flow tube with an internal counter balance mass that operates over a very small range of densities. As a consequence of operating vibrating bending mode process meter designs in flexure, the active bending tube volume may change, causing the fluid to pump back and forth in and out of meter and therefore leaking its energy and force into the connecting pipe boundaries. In so doing the resulting bending mode meter viscosity measurement often needs various complex compensations such as for ambient process conditions and process fluid parameters, which include, but are not limited to, flow rate, density, pressure, viscosity, and temperature. As the required number of compensations for vibrating bending mode process meters increases, resulting measurement parameter accuracy and precision decreases as the necessity of making all the various ancillary measurements and their cross-term compensations increases the design's complexity and cost.

Many of the commercial viscometers available to the market are not capable of measuring the complete fluid stream, flowing into, within or exiting a large process. These are typically only capable of taking smaller side or slip stream samples. The example radial mode fluid process meter enables measurement of the complete fluid stream flowing within a pipe, including large bore. Process meters may be installed at critical process stages, such as fluid entry flow, mid-stage(s) flow and exit flow. Using multiple process meters, it is now possible to make differential measurements of critical process fluid parameters, with more precision than using a single process meter. For example, a less effective method to measure differential process measurements entails using a single process meter at the exit of a process, whereby only the “entry-fluid” flows into the single process meter, whereupon an entry-fluid parameter snapshot reading is taken and thereafter used to make the necessary differential fluid parameter measurements. If entry-fluid parameter(s) significantly change during process runtime, critical output fluid errors may result. The process meter may also continue to measure the necessary fluid properties in zero or minimal flowing conditions, if the fluid remains in an adequately mixed state.

A precision viscosity measurement in a vibrating element type, process meter may need an accurate measurement of the vibrating element “drive-force” and “velocity” and a complete understanding of the variables within the design that influence them. Fluid viscosity can be measured by applying a known force to the vibrating element, which then shears the fluid and thus the fluid and radial mode vibrating element moves with a resulting velocity. Therefore, determining just the force and velocity components attributable to shearing the fluid within the vibrating element process meter and precisely removing any remaining influences yields an accurate viscosity measurement.

When dealing with fluids such as slurries, the viscosity and temperature may be measured on the fluid entering and exiting the liquid plus solid mixing process. Once the “differential” mixing process fluid viscosity measurements are known, the solid and liquid volume fraction or concentration may be calculated, if the relative viscosity of slurry is empirically known. Furthermore, when the application involves a slurry, with knowledge of the solid apparent specific gravity and volume fraction, additional slurry parameters may be further calculated, such as mass fraction or concentration and/or pounds of proppant added (“PPA”). Additional parameter measurement capabilities may be added to the process meter such as mass flow rate, density and/or pressure.

The efficacy of the example radial mode fluid process meter may involve the fact that the viscosity of a fluid can change in a predictable way, as related to the volume fraction of particulate matter added to the fluid. By measuring the viscosity of the base fluid prior to mixing particulate matter therein, and then again measuring the viscosity of the slurry mixture after mixing particulate matter therein, a direct calculation can be made to determine volume fraction.

An equation relating volume fraction to a relative viscosity change shown here below as Equation 2:

μᵣₑₗ=1+2.5*θ Eq2

Where:

μᵣₑₗ=Relative Viscosity

θ=Volume Fraction

The term “relative viscosity” is herein defined as the ratio of the viscosity of the slurry mixture divided by the viscosity of the base fluid as in Equation 3 below:

$${μ}_{rel} = \frac{{μ}_{mixture}}{{μ}_{base fluid}} \qquad Eq 3$$

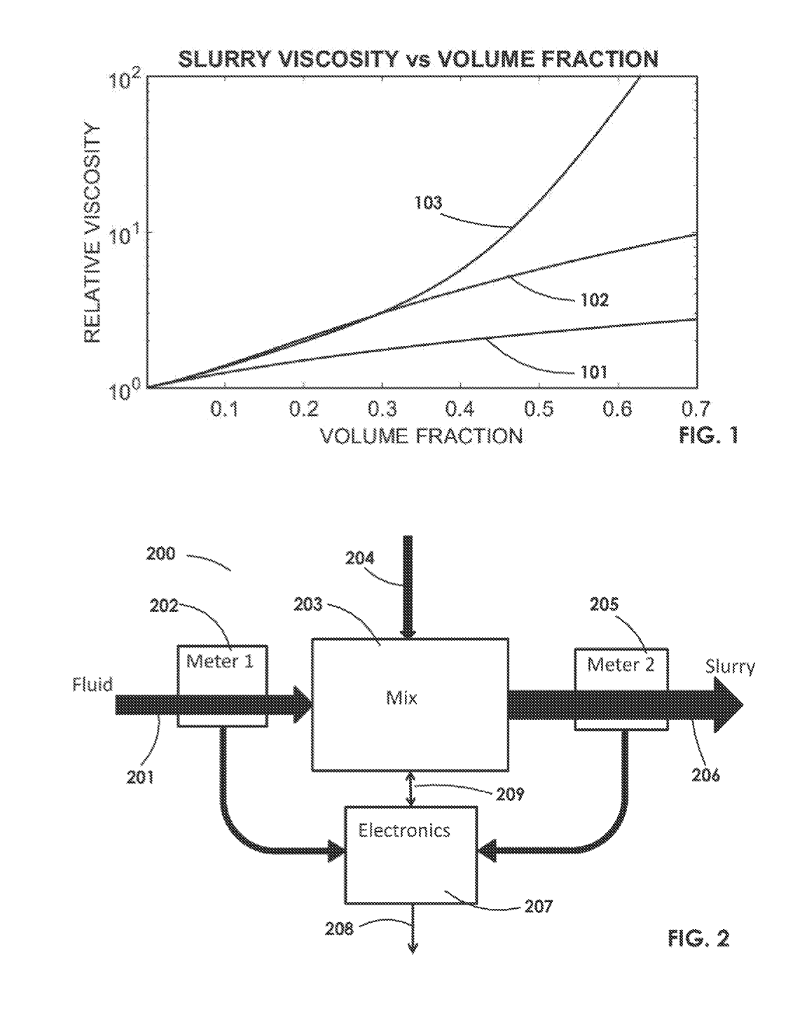

Equation 2 may be shown in graphical form as curve 101 of FIG. 1. Accuracy modifications of Equation 2 are shown in curve 102 and in curve 103. The curve 101 generally may be accurate at very low values of volume fraction, for example 0.1 volume fraction and below. Curves 102 and 103 may extend the accuracy of the equation to higher values of volume fraction. The exact algorithm for the best accuracy depends on the specific fluid parameters since variations in accuracy may occur due to particle size and shape and density. In addition, fluid properties such as shear thinning and/or shear thickening may have a bearing on the final accuracy.

An example radial mode fluid process meter includes at least a first viscosity meter to measure the viscosity of a base fluid, at least a second viscosity meter to measure the viscosity of a slurry mixture, and a control, such as electronics, to receive and act on the viscosity signals, such as by applying an appropriate algorithm to determine the volume fraction of the slurry mixture.

An example radial mode fluid process meter includes an active element type fluid process meter that may use a vibrating inner tube inside a larger conduit operating for example in a radial vibration mode and capable of measuring parameters, such as, but not limited to, fluid viscosity, volume fraction of a slurry, and fluid temperature. The process meter fluid viscosity measurement, viscosity metric, may be defined as a function of the force to drive the modal mass of the inner tube plus the entrained fluid through, for example, its alternating radial elliptical cycle and thus shear the entrained fluid, whereupon the inner tube may attain a measurable controlled velocity. Further compensations to the process meter viscosity metric may improve its accuracy, such as over large changes in process fluid properties such as, but not limited to, Newtonian and non-Newtonian fluids (slurries), density, and temperature.

Process meters that are capable of accurately measuring and/or differentiating between slurry viscosities, solid particles added to carrier fluids, and the initial carrier fluid's viscosities, now may be capable of making additional important fluid measurements, such as slurry solid and liquid volume fraction or concentration. And if the apparent specific gravity of the slurry solid is known, the slurry solid mass fraction or concentration may be calculated.

An example radial mode fluid process meter includes active tubes with holes, multiple active tubes running at different frequencies, non-vibrating element insert of fixed diameter and axial length that may be positioned at the center of the active tube and alternate vibrational modes of operation.

Before continuing, it is noted that as used herein, the terms “includes” and “including” mean, but is not limited to, “includes” or “including” and “includes at least” or “including at least.” The term “based on” means “based on” and “based at least in part on.”

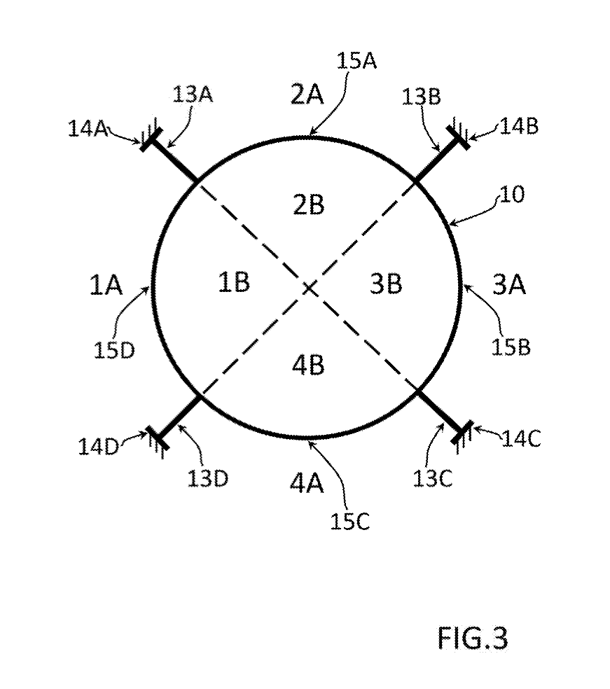

FIG. 1 is a graph of relative viscosity vs. volume fraction showing three example algorithms predicting the relationship therebetween. FIG. 2 is a block diagram of an example radial mode fluid process meter. In an example, the radial mode fluid process meter 200 includes a first viscosity meter 202, a second viscosity meter 205, and electronics 207. The first viscosity meter 202 may be applied to a base fluid 201 to measure its viscosity and to communicate that viscosity to electronics 207. Similarly, a second viscosity meter 205 may be applied to the slurry mixture 206 after the base fluid 201 has been mixed with particles 204 in mixer 203. Viscosity meter 205 measures the viscosity of the slurry mixture 206 and may communicate that viscosity value to electronics 207. Electronics 207 utilizes the two values of viscosity from viscosity meter 202 and viscosity meter 205 to determine a volume fraction output signal 208. Volume fraction output signal 208 can be determined in electronics 207 by the application of an algorithm such as Equation 4 shown below.

$$∅ = \frac{{μ}_{rel} - 1}{2.5} \qquad Eq 4$$

Higher accuracy values of volume fraction may be determined by the use of higher order algorithms, as earlier described herein. For example the equation 102 for relative viscosity may be shown below as Equation 5:

μᵣₑₗ=1+2.5*θ+14.1*θ² Eq 5

Similarly, the equation 103 may be expressed as Equation 6.

μᵣₑₗ=1+2.5*θ+10.05*θ²+0.00273*e^{(16.6*θ)} Eq 6

Other algorithms may be applied in electronics 207 to accurately determine the volume fraction of a slurry mixture.

The exact type of viscosity meter, such as 202 and/or 205, need not be specific to the example radial mode fluid process meter shown, and need not be the same type as each other. In an example, however, viscosity meter 202 measures the viscosity of the fluid 201 and example viscosity meter 205 measures the bulk viscosity of the slurry mixture 206. The term bulk viscosity may be the viscosity of slurry mixture as a whole, including the effects of the added particles 204. This may be relevant in that some viscosity meters may only measure the viscosity of a small sample of the fluid which may not take into effect the interaction of the particles 204 with the fluid 201. For example, some micro-electro-mechanical-systems (MEMS) type viscosity meters may only sample microscopic amounts of fluid, whereas the particles 204 may be much larger than the MEMS viscosity meter itself.

In addition to measuring the volume fraction, electronics 207 may be configured to control the volume fraction signal 208 of slurry mixture 206. Electronics 207 may be configured to communicate with mixer 203 via signals 209, including so that the volume fraction signal 208 may be held to a specific value. In this case, mixer 203 may control the ratio of fluid 201 and particles 204 entering mixer 203 so that a specified volume fraction 208 of the slurry mixture 206 may be controlled and held to a specified value or held to a specified range of values.

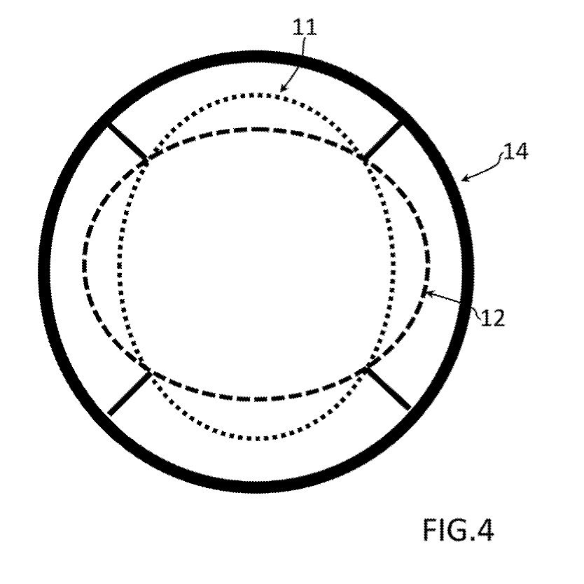

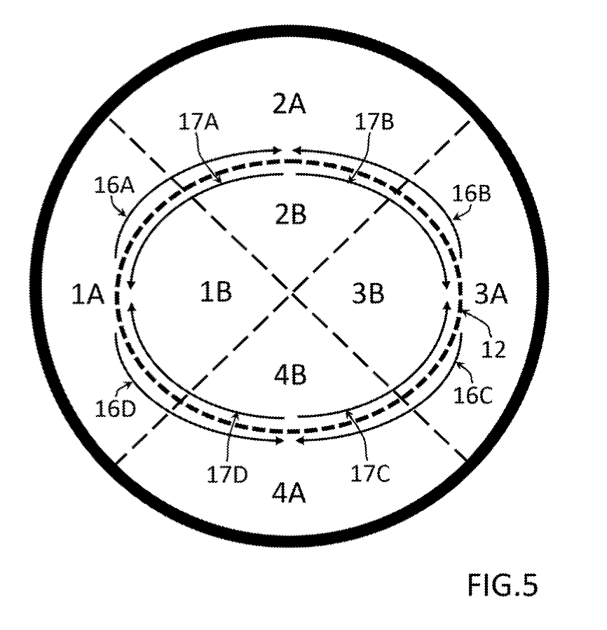

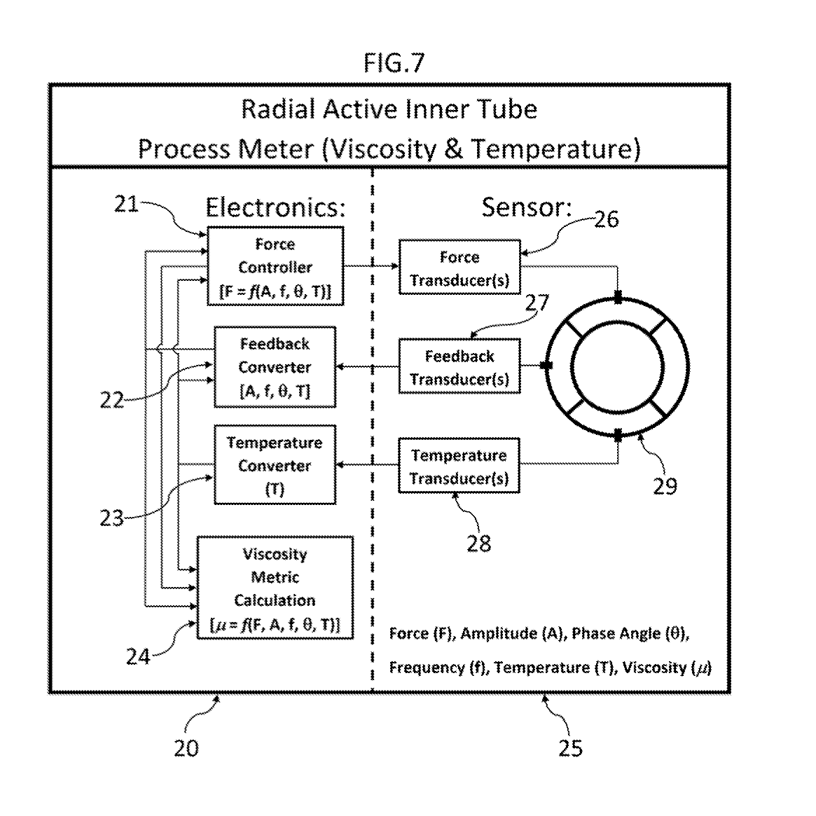

An example process meter is schematically shown in FIG. 7, having an electronics section 20 and a sensor section 25 that may use a radial active inner tube FIGS. 3 and 4, capable of measuring both liquid and slurry fluid parameters including but not limited to fluid viscosity, volumetric fraction and/or concentration and temperature.

FIG. 3 illustrates a radial active tube looking at a cross section of the tube when it is it the neutral position, a circle 10, its four fixed fins as non-vibrating nodes 13A, 13B, 13C and 13D, and their fixed non-vibrating boundary conditions 14A, 14B, 14C and 14D, and the four vibrating antinodes 15A, 15B, 15C and 15D, optimally positioned 45° from each node (not shown).

In this example, the inner tube 10, may be attached such as to four fixed fins 13A, 13B, 13C and 13D. The fins may be attached such as to the inner tube 10 every 90°, where four non-vibrating nodes may be formed down the axial length of the inner tube at each fin attachment point. Each fin may be attached such as to fixed boundary conditions 14A, 14B, 14C and 14D, where these boundaries are considered to be part of a larger conduit that may in whole or part surround the tube.

Also shown are the four fin boundaries 14A, 14B, 14C and 14D, which may be fixed and may not move when the inner tube plus entrained fluid are driven in the radial vibrating mode shape. The fins need not extend down the complete length of tube in order to create the non-vibrating nodes along the inner tube axial length.

The dashed lines that produce an X intersecting through the four fins, may define four separate virtual quadrants down the inner tube axial length, such as with both tube outside diameter and tube inside diameter sections. The inner tube itself, may create a barrier between the outside and inside diameters where the fluid may reside, such as down its axial length, for example where 1A, 2A, 3A and 4A are the virtual inner tube outside diameter sections and 1B, 2B, 3B and 4B are the inside diameter sections. Defining these sections may aid in showing how the fluid flows around the outside and inside circumference of the inner tube, as the inner tube plus entrained fluid cycles through the radial mode shapes.

At the four anti-nodes 15A, 15B, 15C and 15D, positioned in an example, about 45° from each node, a force driver and/or a feedback sensor may be located to both force and/or sense the tube as it may be radially vibrated at one or more frequencies. Other locations may be chosen to locate the force drivers and/or feedback sensors as suitable, however, in an example the design may not be as efficient, and if feedback out divided by force in defines efficiency.

The example radial process meter shown in FIG. 7 may implement electromagnetic transducers to apply force 26 and sense feedback velocity 27. However, other feedback sensors may be utilized as appropriate, including but not limited to displacement, velocity and/or acceleration, and other force transducers may be utilized as appropriate, including but not limited to piezoelectric.

When the inner tube cycles back and forth between its horizontal and vertical elliptical shapes, the peak shapes may be as shown by way of illustration in FIG. 4.

FIG. 4 illustrates an example radial active tube changing shape as it is forced back and forth between a vertical elliptical shape 11 and a horizontal elliptical shape 12 connected to the inside diameter of an external pipe enclosure 14. In an example, the radial active tube changes shape as it is forced back and forth between a vertical elliptical shape 11 and a horizontal elliptical shape 12 connected to the inside diameter of a larger conduit 14. The elliptical tube shapes may extend completely along the inner tube axial length and may vibrate or cycle back and forth, such as between vertical and horizontal elliptical shapes at a frequency determined by the applied force. The external boundary condition may be a larger conduit 14, having little or no vibration that may completely surround the inner tube axial length.

Where the inner tube may shear the fluid as it may be forced to flow radially about itself, as the tube may cycle back and forth between, for example, its horizontal and vertical elliptical shapes, horizontal shape and flow shown in an example in FIG. 5.

FIG. 5 illustrates an example fluid flowing 16A, 16B, 16C and 16D from quadrants 1A and 3A into quadrants 2A and 4A on the outside diameter of a tube and fluid flowing 17A, 17B, 17C and 17D from quadrants 2B and 4B into quadrants 1B and 3B on the inside diameter of a tube, when the radial active tube is forced into its horizontal shape 12. For FIG. 5 illustration clarity, the tube four fixed fins previously depicted in FIGS. 3 and 4 have been virtually eliminated in FIG. 5, but are considered to still exist.

It is noted that the fluid flow from quadrants to quadrants may reverse direction when the inner tube reverses direction and may be forced from its peak horizontal shape 12 and thus may cycle back into its peak vertical shape 11, such as shown in FIG. 4.

In this example, the inner tube 10 may be attached to four fixed fins 13A, 13B, 13C and 13D. The fins may be attached to the inner tube 10 about every 90°, where four non-vibrating nodes may be formed down the axial length of the inner tube at each fin attachment point. Each fin may be attached such as to fixed boundary conditions 14A, 14B, 14C and 14D, where these boundaries are part of a larger conduit that may in whole or part surround the tube.

Also shown are the four fin boundaries 14A, 14B, 14C and 14D, which may be fixed and may not move when the inner tube plus entrained fluid are driven in the radial vibrating mode shape. The fins need not extend down the complete length of tube in order to create the non-vibrating nodes along the inner tube axial length. The dashed lines that produce an X intersecting through the four fins, may define four separate virtual quadrants down the inner tube axial length, such as with both tube outside diameter and tube inside diameter sections.

The inner tube itself, may create a barrier between the outside and inside diameters where the fluid may reside, such as down its axial length, for example where 1A, 2A, 3A and 4A are the virtual inner tube outside diameter sections and 1B, 2B, 3B and 4B are the inside diameter sections. Defining these sections may aid in showing how the fluid flows around the outside and inside circumference of the inner tube, as the inner tube plus entrained fluid cycles through the radial mode shapes.

At the four anti-nodes 15A, 15B, 15C and 15D, positioned in an example about 45° from each node, a force driver and/or a feedback sensor may be located to both force and/or sense the tube as it may be radially vibrated at one or more frequencies. Other locations may be chosen to locate the force drivers and/or feedback sensors as suitable, however, in an example the design may not be as efficient, and if feedback out divided by force in defines efficiency.

The example radial process meter shown in FIG. 7 may use electromagnetic transducers to apply force 26 and sense feedback velocity 27. However, other feedback sensors may be utilized as appropriate, including but not limited to displacement, velocity and/or acceleration, and other force transducers may be utilized as appropriate, including but not limited to piezoelectric.

When the inner tube cycles back and forth between its horizontal and vertical elliptical shapes, the peak shapes may be as shown in an example in FIG. 4. FIG. 4 illustrates a radial active tube changing shape as it is forced back and forth between a vertical elliptical shape 11 and a horizontal elliptical shape 12 connected to the inside diameter of a larger conduit 14. The elliptical tube shapes may extend completely along the inner tube axial length and may vibrate or cycle back and forth, such as between vertical and horizontal elliptical shapes at a frequency determined by the applied force. The external boundary condition may be a larger conduit 14, having little or no vibration that may completely surround the inner tube axial length.

Where the inner tube may shear the fluid as it may be forced to flow radially about itself, as the tube may cycle back and forth between, for example, its horizontal and vertical elliptical shapes, horizontal shape and flow shown in an example in FIG. 5. FIG. 5 illustrates the fluid flowing 16A, 16B 16C and 16D such as from quadrants 1A and 3A into quadrants 2A and 4A on the outside diameter of the inner tube when forced into its horizontal shape 12. FIG. 5 also may illustrate the fluid flowing 17A, 17B, 17C and 17D such as from quadrants 2B and 4B into quadrants 16 and 36 on the inside diameter of the inner tube when forced into its horizontal shape 12. The fluid flow from quadrants to quadrants may reverse direction when the inner tube reverses direction and may be forced from its peak horizontal shape 12 and thus may cycle back into its peak vertical shape 11, such as may be shown in FIG. 4.

The example radial mode fluid process meter may be capable of measurements including fluid viscosity, slurry volume fraction, and fluid temperature. Fluid viscosity, μ, may be defined as surface area, A, traveling at velocity, ν, with an applied drive Force, F, where fluid may undergo a shear stress and a varying gradient may be formed across distance, y, which may extend from static fluid to maximum fluid flow velocity, at surface area, A. Equation 7 is an example formula for fluid viscosity.

$$μ = \frac{F}{v} \frac{y}{A} \qquad Eq 7$$

The inner tube may have an area, A, that may oscillate back and forth between, for example, horizontal and vertical ellipses at a peak velocity, ν=Aω, when it is driven by an oscillating Force, F. The fluid contained by the process meter may be in contact with its inner tube outside diameter and inside diameter, and thus may undergo a shear stress, such as shown in an example in FIG. 4, with a varying gradient as the fluid may fill the distance between the process meter fluid stationary boundary conditions and thus the inner tube's maximum velocity, ν=Aω. Where the inner tube horizontal and vertical elliptical shape peak displacement is A, ω=2πf and f is the frequency of oscillation. A frequency of operation for the inner tube and the fluid surrounding it may be the first natural radial mode of vibration f_{NR}, where its shape is depicted in FIG. 4 and may be inherently balanced, as its center of gravity may remain at the center of the inner tube, if the modal mass of the entrained fluid is adequately mixed. The process meter feedback transducer may be an electromagnet, where its voltage output, V, may be a function of the magnetic field B and length of coil winding wire L and the velocity with which the transducer preferably sinusoidally oscillates, again at the active tube's peak velocity, ν=Aω. Equation 8 represents the sinusoidal formula for feedback velocity.

V(τ)=BLν=BLAω sin(2πft) Eq 8

The process meter oscillatory drive force, F, may be sinusoidal and may be produced by an electromagnetic transducer where it may be a function of the magnetic field B, the length of wire L on its coil winding, the peak current I flowing through coil winding, its frequency f, and its phase angle θ relative difference from tube sinusoidal velocity ν, may all be electronically maintained by a closed loop force controller and may be temperature compensated by the meter sensor temperature transducer(s). Equation 9 represents the sinusoidal formula for drive force.

F(τ)=BL1 sin(2πft+θ) Eq 9

Returning to Equation 7 both numerator and denominator may cancel if they have the same physical properties and y/A variations may be ratiometric and thus become a constant K. Therefore, the viscosity metric output by the example process meter may be a function of drive transducer current I and feedback transducer velocity ν times a constant K.

Equation 10 may show the simplification.

$$μ = \frac{BLI sin ( 2 π ft + θ )}{BLv sin ( 2 π ft )} \times \frac{y}{A} = {K}_{v}^{I} \qquad Eq 10$$

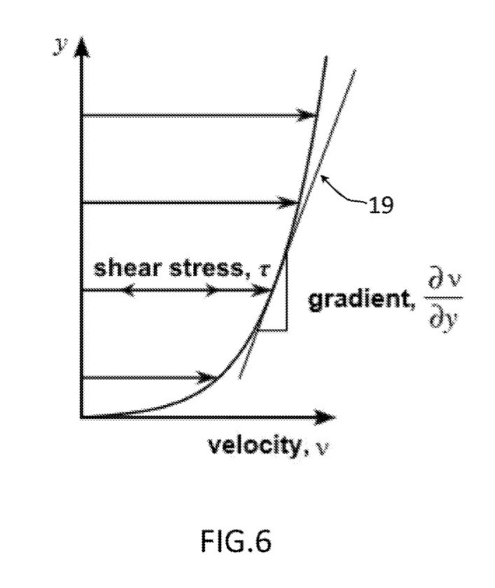

FIG. 6 illustrates 19 a shear stress profile τ in an example for fluid flowing at velocity ν with a distance y between flowing and stationary fluid. FIG. 7 illustrates an example radial active inner tube process meter, comprised of its two main sections, electronics 20 and sensor 25, which together measures and outputs fluid parameters, viscosity and temperature.

The viscosity metric calculation block 24 may perform the mathematics necessary to produce the viscosity metric output. In 24 the viscosity metric μ=f(I, A, f, θ, T) may be shown to be a function of drive current I, velocity if with A and f (ν=A2πf), phase angle θ being the angle between the velocity and drive current used in order to calculate their respective RMS values, and temperature T being used to compensate for inner tube elastic modulus changes, abrupt physical size changes due to temperature shock induced shrinkage and/or growth, which may also induce significant stress and its temperature compensation.

With a viscosity metric output, further important differential fluid calculations may be performed on non-newtonian fluids such as slurries. Differential being for example first the carrier liquid viscosity, before solids are added to a mixing process, and second the slurry viscosity. In an example, the slurry may be an adequately mixed fluid as it exits the mixing process and is measured. With both carrier liquid viscosity and slurry viscosity entering and exiting a mixing process respectively volume fraction or concentration of the liquids and solids may be calculated. Relative viscosity, μR, a dimensionless quantity may be equal to the slurry viscosity, μS, divided by the carrier liquid viscosity, μL. Equation 11 represents the relative viscosity:

μ_{R}=μ_{S}/μ_{L} Eq 11

Relative viscosity, μR, may be also a function of volume fraction, φV, of the solid in the liquid, where Einstein first proposed that μR=1+2.5 φV. However this linear approximation may be best for the 2 dimensional case, when typically solid, volume fraction is typically less than 15% of the slurry volume.

Above 15% the error in the solid volume fraction calculation may become significant to the measurement, where the solid particles start to interact with each other in the third dimension, requiring higher order volume fraction terms. Equation 12 represents the form for relative viscosity as function of volume fraction for the three dimensional case:

μ_{R}=1+K_{1Vφ}_{_{V}}+K_{2Vφ}_{_{V}}^{2+ . . .} Eq 12

In Equation 12 above, the final number of volume fraction terms and their respective constants may be found empirically with a specific application, where solid particle properties such as size, shape, surface roughness all may play a part in making both sides of the equation equal. Once relative viscosity has been determined along with the associated constants for an application, volume fraction may be solved for. With modern electronics, multiple relative viscosity equations for various applications may be stored in memory and utilized appropriately such as to calculate and output the correct volume fraction.

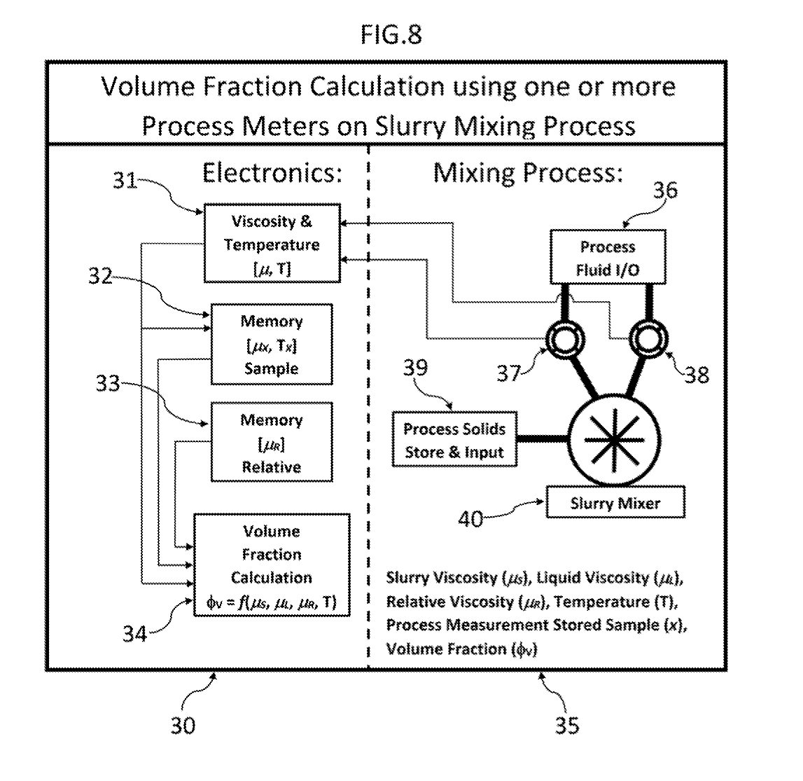

FIG. 8 illustrates an example Volume Fraction Calculation using one or more process meters on slurry mixing process, comprised of its two main sections, electronics 30 and mixing process 35 that contains a process meter 37, which together measures, calculates and outputs fluid parameter, slurry volume fraction and temperature.

FIG. 8 illustrates an example mixing process 35 such as using process meters 37 and 38 capable of measuring input and output fluid viscosity and temperature, where these measurements may be sent to an electronics 30, read by 31 and if necessary at least one stored into memory 32, then using an appropriate relative viscosity equation 33, together may be capable of calculating and outputting slurry volume fraction 34.

FIG. 8 also illustrates the capability of using a single process meter, such as either 37 or 38, where the input liquid viscosity and temperature may be captured and held in memory so that they may be continuously used by the slurry volume fraction calculation block 34 whereupon the same input process meter and piping may be used as the mixed slurry output. This described single process meter mixing use case may lower the mixing process capital cost.

However, when a single process meter mixing use case is adopted, it generally provides less effective slurry volume fraction measurements. It is generally be the case that the carrier fluid viscosity entering the slurry mixing process may substantially change over time for the slurry batch, as viscosity may be extremely temperature dependent. Furthermore, the carrier liquid viscosity reading taken at the beginning of the process by the single process meter and utilized for such measurements as volume and mass fraction, may not have been an acceptable viscosity sample within the carrier fluid's normal process distribution, which then may adversely bias all subsequent slurry measurements. It is generally the case that any multiple of process meters with either input or output fluid flow capability, may be connected to a mixing process and their viscosity and temperature measurements may be sent to the electronics for use in slurry volume fraction calculations. And with slurry volume fraction, if the apparent specific gravity of the solid used to make the slurry is known, the solid mass fraction or concentration of the slurry may be calculated and output.

In addition relative viscosity, μ_{R}, may be a curve fit method that may determine slurry volume fraction, φ_{V}, a similar curve fit method may be used using viscous penetration depth, δ, which may be an estimation for the thickness or depth of the liquid boundary layer surrounding particles in a slurry. Viscous penetration depth, δ, may be a function of viscosity, μ, density, ρ, and frequency of oscillation, f. Equation 13 represents viscous penetration depth:

δ=\sqrt{2μ/(fρ)} Eq 13

Normally the particle in viscous penetration depth may be defined as a solid, but for the purposes of defining this relative viscous penetration depth curve fit method, the term “particle” may apply to both the solid and liquid so that their viscosity, density and frequency of oscillation measurements from a device such as a process meter can be utilized. Describing relative viscous penetration depth, δ_{R}, as a dimensionless quantity and equal to the slurry viscous penetration depth, δ_{S}, divided by the carrier liquid viscous penetration depth, δ_{L}. Equation 14 represents the relative viscous penetration depth:

δ_{R}=δ_{S}/δ_{L} Eq 14

Equation 15 represents the form for relative viscous penetration depth as function of slurry volume fraction:

δ_{R}=1+K_{1Vφ}_{_{V}}+K_{2Vφ}_{_{V}}²+ . . . Eq 15

For equation 15 above, the final number of volume fraction terms and their respective constants, may be found empirically for a specific application, where solid particle properties such as size, shape, surface roughness all may a part in making both sides of the equation equal. Once relative penetration depth has been, determined along with the associated constants for a specific application, volume fraction may be solved for. Similarly, as viscous penetration depth may be a function of density, the curve fit method may also apply to slurry mass fraction, φ_{M}, where the ratio may be equal to mass fraction constants and thus may make both sides of Equation 16 equal.

δ_{R}=1+K_{1Mφ}_{_{M}}+K_{2Mφ}_{_{M}}²+ . . . Eq 16

For equation 16, the final number of mass fraction terms and their respective constants, may be found empirically with a specific application, where solid particle properties such, as size, shape, surface roughness all may play a part. Once relative penetration depth has been determined along with any associated constants for a specific application, mass fraction may be solved for.

Further, the above calculations for volume fraction and mass fraction may be described as curve fits that are “relative” ratios of selected slurry properties divided by the associated liquid carrier properties, such as viscosity and/or a similar viscosity metric of force divided by velocity, F/ν. Similar relative ratios involving force divided by acceleration, F/a, and force divided by displacement, F/d, may also be used to find acceptably accurate curve fits as a function of volume fraction and/or mass fraction for slurry applications, such as where F is force, d is displacement, ν is velocity or displacement times radian frequency, dω, a is acceleration or displacement times radian frequency squared, dω², ω=2πf and f is the frequency of oscillation. Frequency of oscillation f is now defined, therefore other possible relative ratios that curve fit volume fraction and mass fraction can be composed of some or all of the frequency permutations that may utilize slurry frequency, f_{S}, and/or carrier liquid frequency, f_{L}.

In addition, it may also be possible to curve fit acceptably accurate relative ratios that may determine slurry volume fraction and/or slurry mass fraction that may be composed of any or all the possible permutations of force divided by acceleration, a, velocity, ν, and displacement, d. For example, a volume fraction and/or mass fraction curve fit may be defined and possibly composed of slurry force and slurry acceleration, F_{S}/a_{S}, divided by possibly the associated liquid carrier force and liquid carrier displacement, F_{LC}/d_{LC}. Since volume fraction and mass fraction curve fits may be set to relative ratios, where the curve fits may be composed of constants and their associated higher order terms, the necessary possible signal processing that may solve for mass fraction or volume fraction may take up significant processor bandwidth as the number of curve fit constants and associated higher order terms increase. Therefore, mathematical operators may first be applied to possible mass fraction and volume fraction relative ratios before they are curve fit by possible constants and associated higher order terms, where the possible mathematical operator's purpose may be to simplify the curve fit where it then may reduce signal processing bandwidth requirements. Possible mathematical operators include, but are not limited to, square root, powers, trigonometric, and hyperbolic.

When slurry density is measured by a vibrating element type densitometer, its physics may dictate that the solid particle's amplitude and phase relative to the carrier liquid's amplitude and phase may be different. The amount of relative difference or slippage may be dependent upon physical properties of both the carrier liquid and solid. If slurry slippage is occurring inside the vibrating element type densitometer, the meter may not measure the correct slurry density as the full mass of the slurry may be slipping relative to the motion of the meter's vibrating element. Therefore, a vibrating element type densitometer may need to correct its “apparent” density, ρA, measurements on slurries when total mass slippage errors occur.

A slurry density correction method is made possible using slurry specific gravity, SG_{S}, which may be calculated from slurry volume fraction, φ_{V}, carrier liquid specific gravity, SG_{L}, and solid particle apparent specific gravity, SG_{P}, used to make the slurry. Equation 17 represents slurry specific gravity:

SG_{S}=SG_{L}+φ_{V}×(SG_{P}−SG_{L}) Eq 17

Therefore, with slurry specific gravity, SG_{S}, and water density, ρ_{W}, the slurry density, ρ_{S}, may be calculated. Equation 18 represents slurry density:

ρ_{S}=SG_{S}×ρ_{W} Eq 18

Thus the density error, % Err_{D}, can be calculated with the slurry density, ρ_{S}, and the vibrating element densitometer slurry apparent density, β_{A}. Equation 19 represents slurry density error for a vibrating element densitometer:

% Err_{D}=(1−ρ_{A}/ρ_{S})×100% Eq 19

Furthermore, knowing slurry specific gravity, SG_{S}, solid particle apparent specific gravity, SG_{P}, and slurry volume fraction, φ_{V}, slurry mass fraction can be calculated, φ_{M}. Equation 20 represents slurry mass fraction:

φ_{M}=φ_{V}×SG_{P}/SG_{S} Eq 20

An example process meter includes inner tubes with holes, multiple inner tubes running at different frequencies, non-vibrating element insert of fixed smaller diameter and axial length that may be positioned at the center of the inner tube and differing inner tube vibrational modes of operation. Inner tubes with holes enables the fluid to flow from outside to inside diameter or vise-versa without traversing around one or both of the inner tube open ends, which may lower inner tube vibrational mode power requirements when operating in highly viscous fluid applications. Multiple inner tubes enables time consuming compensation algorithms and/or secondary vibrational mode behaviors to be performed on one or more inner tube(s), while the other tube(s) may be continuously running primary variable operations and their associated vibrational behavior such as, but not limited to, viscosity, density, and mass-flow.

Non-vibrating element insert of fixed radial size and axial length that may be positioned at the center of the inner tube, where it may provide a fixed non-vibrating fluid boundary condition facing the inner tube inside diameter, such as the larger conduit inside pipe wall may provide a fixed non-vibrating fluid boundary condition surface facing the inner tube outside diameter. An example may be a round insert of fixed diameter and axial length that may have minimal axial length of active tube. Various vibrational mode designs of higher order and/or unbalanced for inner tube operation other than the quadrature radial mode may be more complex and costly to implement, but none the less may be capable of producing fluid measurements.

In addition, for many fluid process control applications a very important concept is specific gravity. Where specific gravity is the ratio of the density of a substance to the density of a reference substance, and substantially identical volumes, it simplifies to the ratio of the mass of a substance to the mass of a reference substance. Similarly, the idea of specific viscosity may be implemented. Where specific viscosity, SV, may then be defined as the ratio of the viscosity of a substance, μ_{S}, to the viscosity of reference substance, μ_{RS}, at specified standard temperature and pressure conditions.

SV=μ_{S}/μ_{RS} Eq 21

The viscosity values utilized in Equation 21, may also include the direct use of viscosity metric values as defined earlier.

It also important to note that many viscometers on the market today typically do not correlate well with each other when outputting standard fluid viscosity units, example Centipoise. Viscometer measurements tend to be both device type dependent and fluid ambient condition dependent, which may make it hard to correlate between a lab viscometer and an inline process viscometer. As an alternative, the specific viscosity concept may be utilized, which now makes the measurement ratio-metric.

With this paradigm applied to lab and fluid process control applications, it now has important implications. The first and easiest being, make the reference viscosity substance water at standard temperature and pressure, then all subsequent viscosity measurements of a substance of interest are relative to water on the chosen viscometer. A second method that is easily understand with applications involving fluid process control, within the process's normal distribution may use the process fluid's optimal viscosity value as the reference viscosity on the chosen viscometer. Then with process control applications, the specific viscosity control value is one and thus normalized to the application process, where then easily understood process control limits become implemented as simple percentages. A possible means to calibrate the second method, again utilizes a well characterized fluid such as water at standard temperature and pressure, and thus ensure the viscometer has not lost its calibration. With many process control engineers, the control measurement of interest may have sensitivity and repeatability to maintain their application's process yield, which may be achieved by using the specific viscosity paradigm. And thus outputting and calibrating to standard viscosity units, such as Centipoise, become less critical.

It is noted that the examples shown and described are provided for purposes of illustration and are not intended to be limiting. Still other examples are also contemplated.

1. A method of measuring volume fraction of particles in a base fluid comprising a slurry mixture, the method comprising:
measuring a first viscosity of the base fluid prior to mixing with the particles;
measuring a second viscosity of the slurry mixture;
determining a volume fraction by an algorithm executing by control electronics based on the first viscosity and the second viscosity; and
generating an output signal from the control electronics proportionally related to the volume fraction, the output signal configured to the measuring.

2. A process meter for measurement of volume fraction of a slurry mixture, the slurry mixture comprising a combination of a fluid with solid particles, the process meter comprising:
a first viscosity meter configured to measure a first viscosity of the fluid and to generate a first viscosity signal proportionally related to the first viscosity;
a second viscosity meter configured to measure a second viscosity of the slurry mixture and to generate a second viscosity signal proportionally related to the second viscosity;
control electronics configured to receive the first viscosity signal and the second viscosity signal, and to calculate a volume fraction of the solid particles in the slurry mixture based on the first viscosity signal and the second viscosity signal; and
wherein the control electronics is configured to create an output signal from the process meter proportionally related to the volume fraction, and to measure the volume fraction.

3. The process meter of claim 2, wherein the control electronics controls the volume ratio to a specified value.

4. The process meter of claim 2, wherein the second viscosity meter is a vibrating element type fluid parameter meter which measures the bulk viscosity of the slurry mixture.

5. The process meter of claim 2, wherein the second viscosity meter is a radial mode vibrating element type fluid parameter meter.

6. A process meter using a vibrating element for measuring and outputting at least one fluid parameter, the process meter comprising:
an outer conduit assembly conveying a fluid;
an inner sensor assembly having at least one straight vibrating uniform inner sensor element;
at least one mounting flexure providing fixed attachment between the outer conduit assembly and the inner sensor assembly;
at least one force transducer to cause the inner sensor assembly to vibrate;
at least one feedback transducer to sense feedback vibration from the inner sensor assembly;
at least one fluid temperature transducer positioned to measure temperature of the fluid;
at least one conduit temperature transducer positioned to measure the ambient temperature of the outer conduit assembly;
control and feedback electronics connected with the force transducer, the feedback transducer, the fluid temperature transducer, and the conduit temperature transducer, the control and feedback electronics cooperating to controllably vibrate or oscillate the inner sensor assembly and the fluid; and
wherein the control and feedback electronics produce at least one output signal proportionally related to the at least one fluid parameter.

7. The process meter of claim 6, wherein the least one fluid par et is selected from at least one of fluid viscosity and fluid temperature.

8. The process meter according of claim 6, wherein the inner sensor assembly is configured to operate in one or more balanced radial or hoop modes of vibration for the purpose of producing radial oscillatory fluid motion and shearing on the fluid.

9. The process meter according of claim 6, wherein the fluid temperature transducer signals in combination with the conduit temperature transducer signals temperature compensate and minimize absolute, relative, and/or differential temperature dependent effects for the outer conduit assembly and inner sensor assembly

10. The process meter according of claim 6, wherein the fluid temperature transducer signals in combination with the conduit temperature transducer signals temperature compensate and minimize absolute, relative, and/or differential temperature dependent effects for transducers.

11. The process meter according of claim 6, wherein the fluid temperature transducer signals in combination with the conduit temperature transducer signals temperature compensate and minimize absolute, relative, and/or differential temperature dependent effects for fluid parameter outputs.

12. The process meter according of claim 6, wherein the feedback transducer senses and outputs a signal proportional to at least one of the inner sensor assembly oscillatory displacement, oscillatory velocity, oscillatory acceleration, and oscillation frequency.

13. The process meter according of claim 6, wherein an oscillatory drive excitation input signal of known amplitude, known, frequency and known phase excites the force transducer to sustain vibration on the inner sensor assembly and the fluid, where the known phase is relative to the feedback transducer output signal.

14. The process meter according of claim 6, wherein the fluid viscosity output signal is proportional to the feedback transducer output signal and the drive excitation input signal and the radial oscillatory fluid shearing.

15. The process meter according of claim 6, wherein the inner sensor assembly is comprised of more than one independent vibrating inner sensor elements, each of the independent inner vibrating sensor elements capable of mutually exclusive operations for operating multiple radial modes of vibration to improve process meter performance with regard to fluid parameter output accuracy, variation, and latency, with the independent vibrating inner sensor elements only common coupling being through the process meter fluid and being through shared control and feedback electronic calculations.

16. The process meter according of claim 6, wherein the inner sensor assembly is configured to operate in an alternate balanced radial or hoop mode of vibration, where the alternate radial mode of vibration operates in a common mode of vibration relative to the radial modes of vibration for operating multiple radial modes of vibration to improve process meter performance for fluid parameter output accuracy, variation, and latency, with the multiple radial modes of vibration only common coupling being through shared inner sensor assembly common mode noise and the process meter fluid and being through any shared control and feedback electronic calculations.

17. The process meter according of claim 6, wherein the inner sensor assembly has a radially centered non-vibrating smaller fixed diameter element and a fixed axial length, where the surface area of the smaller fixed diameter element provides a non-vibrating surface area boundary condition for the fluid on the inside diameter of the inner sensor assembly.

18. The process meter according to claim 6, wherein at least one fluid viscosity measurement is held in memory of the control electronics and used as a constant for at least one the slurry volume fraction calculation for a fixed period of time.

19. A method of operating a process meter to measure and output at least one fluid parameter of a fluid comprised of at least one combination of liquids, solids and/or slurry at any process stage, the method comprising:
at least one mixing stage to measure and/or change and/or control solids volume and/or mass fraction content in a mixing stage slurry output, the mixing stage having a plurality of the liquids, or the solids, or the slurry as mixing stage inputs resulting in the mixing stage output;
utilizing at least one fluid viscous penetration depth measurement on the mixing stage inputs and the mixing stage output;
utilizing the fluid viscous penetration depth mixing stage inputs and the fluid viscous penetration depth mixing stage slurry output to perform a slurry volume fraction calculation and/or slurry mass fraction calculation and outputs;
wherein the slurry volume fraction calculation and/or mass fraction calculation is a proportional calculation of the mixing stage slurry viscous penetration depth output divided by the mixing stage fluid viscous penetration depth inputs; and
wherein the proportional calculation includes either linear or higher order terms involving the slurry volume fraction and/or slurry mass fraction output.

20. The method of claim 19, wherein at least one of the fluid viscous penetration depth measurements is held in memory of the calculation electronics and used as a constant for at least one the slurry volume fraction calculation and/or slurry mass fraction calculation for a fixed time.
